(19) United States
(12) Patent Application Publication
(10) Pub. No.: US 2007/0026274 A1
(43) Pub. Date: Feb. 1, 2007

(54) FUEL CELL SYSTEM AND CONTROL METHOD FOR FUEL CELL SYSTEM

(75) Inventors: Masato AKITA, Yokohama-shi (JP); Takahiro Suzuki, Chuo-ku (JP); Tomohiro Hirayama, Oume-shi (JP); Terumasa Nagasaki, Oume-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/460,476

(22) Filed: Jul. 27, 2006

(30) Foreign Application Priority Data
Jul. 28, 2005 (JP) 2005-218441

(51) Int. Cl. H01M 8/04

(52) U.S. Cl. 429/22; 429/24; 429/13

(57) ABSTRACT

A fuel cell system includes an anode electrode to which fuel is to be supplied; a cathode electrode to which an oxidant containing air or oxygen is to be supplied; an electrolyte membrane disposed between the anode electrode and the cathode electrode; a catalyst section configured to accelerate a chemical reaction of at least a portion of a material discharged from the cathode electrode and a material discharged from the anode electrode; an oxidant supply unit configured to supply the oxidant to the cathode electrode; and a control unit configured to control an amount of the oxidant to be supplied to the cathode electrode. The control unit controls the oxidant supply unit to increase the amount of the oxidant to be supplied to the cathode electrode when the oxidant supply unit starts to operate.

### CROSS REFERENCE TO RELATED APPLICATIONS

This application is based upon and claims the benefit of priority from the prior Japanese Patent Application No. 2005-218441, filed on Jul. 28, 2005: the entire contents of which are incorporated herein by reference.

### BACKGROUND OF THE INVENTION

1. Field of the Invention

The present invention relates to a fuel cell system, and to a method for operating the same. The invention particularly relates to a fuel cell system having a catalyst section for accelerating a chemical reaction of at least a portion of materials discharged from the fuel cell system, as well as to a control method therefor.

2. Description of the Related Art

In recent years, a liquid fuel cell, such as a direct methanol fuel cell, has become a focus of attention. An electromotive section unit of the direct methanol fuel cell includes an anode, a cathode, and a proton conductive electrolyte membrane (e.g., a perfluoro sulfonic acid ion exchange membrane; Nafion™ manufactured by DuPont Co., or the like, is employed) disposed between the anode and the cathode. For activating the fuel cell, methanol and water are supplied to the anode, and an oxidant; e.g., an oxygen gas or air, is supplied to the cathode, thereby inducing respective chemical reactions at the anode and the cathode.

As a result of the chemical reactions, electrons, protons, and carbon dioxide are produced, and the thus-produced carbon dioxide is released to the atmosphere. The electrons are taken out through an external circuit, and are utilized as electric power. The protons move through the proton conductive electrolyte membrane, and arrive at the cathode. In a cathode catalyst layer, the protons react with electrons having been utilized as electric power, and oxygen, to thus produce water. Hence, power generation is attained.

In this electrode reaction of methanol which occurs in the anode, formaldehyde, formic acid, and the like, which are considered reactive intermediates during the process until complete oxidation is achieved, may be discharged from the electrode as byproducts without being subjected to reaction. In addition, methanol in the fuel having been supplied to the anode may move through the proton conductive electrolyte membrane and the catalyst layer to the cathode by means of diffusion, and the like, and be oxidized by the oxidant having been supplied to the cathode, thereby also producing by products, such as formaldehyde, formic acid, or the like, during this process.

To this end, there has been disclosed a fuel cell system which employs a catalyst for rendering byproducts harmless in a path through which carbon dioxide, water, and byproducts are discharged from the fuel cell system (See, for example, JP-A-2005-183014, FIG. 19).

However, when the fuel cell system is stopped, supply of oxidant to a cathode is also stopped. Therefore, most of the residual byproducts in the cathode remain in the vicinity of the cathode in an unreacted state until the fuel cell system is restarted.

Furthermore, since supply of the oxidant to the cathode is stopped, during the stopped state of the fuel cell system, most of the methanol having been diffused toward the cathode through the proton conductive electrolyte membrane remains in the vicinity of the cathode in an unreacted state until the fuel cell system is restarted.

Accordingly, upon restart of the fuel cell system, the byproducts and methanol of significantly high concentration are to be supplied to the catalyst. Therefore, an excessive amount of catalyst relative to that required in a continuous power generation state of the fuel cell system must be provided, thereby making miniaturization and cost reduction of the fuel cell system difficult.

The present invention provides a fuel cell system which can be miniaturized by means of reducing an amount of catalyst required at restart of the fuel cell system, as well as a control method for the fuel cell system.

### SUMMARY OF THE INVENTION

According to an aspect of the invention, a fuel cell system includes: an anode electrode to which fuel is to be supplied; a cathode electrode to which an oxidant containing air or oxygen is to be supplied; an electrolyte membrane disposed between the anode electrode and the cathode electrode; a catalyst section configured to accelerate a chemical reaction of at least a portion of a material discharged from the cathode electrode and a material discharged from the anode electrode; an oxidant supply unit configured to supply the oxidant to the cathode electrode; and a control unit configured to control an amount of the oxidant to be supplied to the cathode electrode. The control unit controls the oxidant supply unit to increase the amount of the oxidant to be supplied to the cathode electrode when the oxidant supply unit starts to operate.

According to another aspect of the present invention, a control method for a fuel cell system which includes: an anode electrode to which fuel is to be supplied; a cathode electrode to which an oxidant containing air or oxygen is to be supplied; an electrolyte membrane disposed between the anode electrode and the cathode electrode; a catalyst section configured to accelerate a chemical reaction of at least a portion of a material discharged from the cathode electrode and a material discharged from the anode electrode; and an oxidant supply unit configured to supply the oxidant to the cathode electrode, the method includes: starting an operation of the oxidant supply unit; and controlling the oxidant supply unit to make Q0 smaller than Qt, wherein Q0 is an amount of the oxidant to be supplied to the cathode electrode at a start-up of the oxidant supply unit, and Qt is an amount of the oxidant to be supplied to the cathode electrode after lapse of a predetermined time from the start-up of the oxidant supply unit.

According to yet another aspect of the present invention, a control method for a fuel cell system which includes: an anode electrode to which fuel is to be supplied; a cathode electrode to which an oxidant containing air or oxygen is to be supplied; an electrolyte membrane disposed between the anode electrode and the cathode electrode; a catalyst section configured to accelerate a chemical reaction of at least a portion of a material discharged from the cathode electrode and a material discharged from the anode electrode; a fuel supply unit configured to supply the fuel to the anode electrode; and an oxidant supply unit configured to supply the oxidant to the cathode electrode, the method includes: starting up an operation of the oxidant supply unit at a start-up of the fuel cell system; increasing an amount of the oxidant to be supplied to the cathode electrode by the oxidant supply unit after lapse of a predetermined time from the start-up of the operation of the oxidant supply unit; starting up an operation of the fuel supply unit after the amount of the oxidant to be supplied is increased; and supplying a load with electric power generated by the anode electrode, the cathode electrode, and the electrolyte membrane after the start of the operation of the fuel supply unit.

The present provides a fuel cell system which is reduced in an amount of catalyst required upon restart of the fuel cell system, thereby reducing the size of the system.

### BRIEF DESCRIPTION OF THE DRAWINGS

FIG. 1 is a view illustrating a fuel cell system according to an embodiment of the invention;

FIG. 2 is a view illustrating details of an electromotive section of the fuel cell system according to the embodiment;

FIG. 3 is a view illustrating details of a catalyst section of the fuel cell system according to the embodiment;

FIG. 4 is a view illustrating control of the fuel cell system according to the embodiment;

FIG. 5 is a view showing a methanol concentration according to Example;

FIG. 6 is a view showing a methanol concentration according to Example;

FIG. 7 is a view showing transition of temperature according to the Example; and

FIG. 8 is another view showing transition of the temperature according to the Example.

### DETAILED DESCRIPTION OF THE INVENTION

An embodiment of the invention will be described by reference to the drawings.

### Embodiment

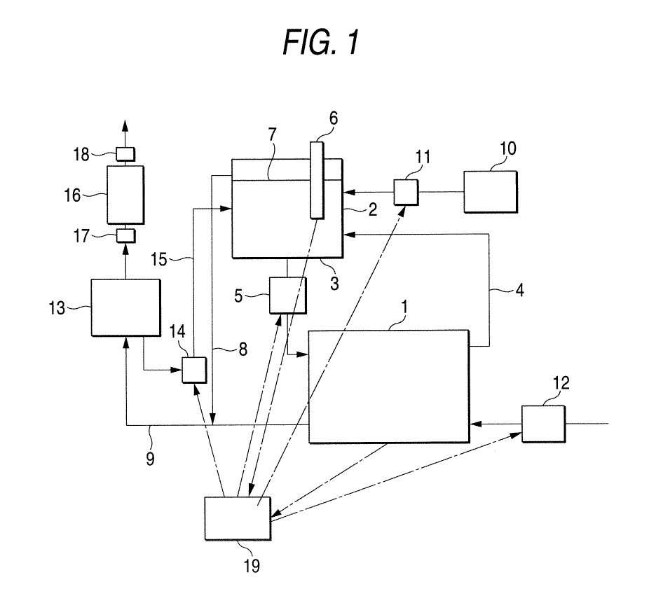

FIG. 1 illustrates a fuel cell system according to an embodiment of the invention. Arrows of a solid line in the drawing indicate flows of fuel 2, discharged materials, and the like, which will be described later; and arrows of a dot-dashed line indicate flows pertaining to data, such as output signals and control signals.

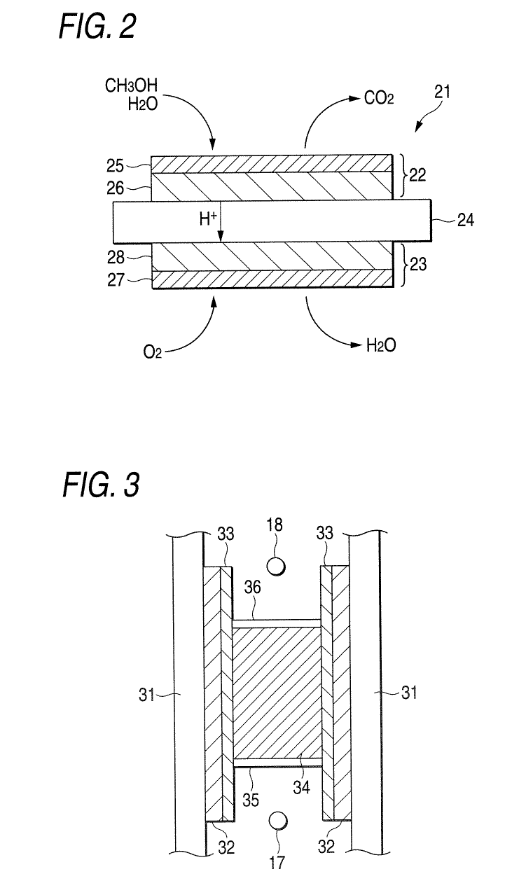

The fuel cell system includes an electromotive section 1. As the electromotive section 1, e.g., a member formed by means of stacking a plurality of electromotive section unit cells 21 illustrated in FIG. 2 can be employed.

Each of the electromotive section unit cells 21 (hereinafter called a “cell”) includes an anode 22, a cathode 23, and a proton conductive electrolyte membrane 24 (electrolyte membrane). The proton conductive electrolyte membrane 24 is disposed between the anode 22 and the cathode 23. As the proton conductive electrolyte membrane 24, e.g., a perfluoro sulfonic acid ion exchange membrane, such as Nafion™ manufactured by DuPont Co., can be employed.

The anode 22 includes a substrate 25, and an anode catalyst layer 26 stacked on the substrate 25. Meanwhile, the cathode 23 includes a substrate 27, and a cathode catalyst layer 28 stacked on the substrate 27. Each of the anode catalyst layer 5 26 and the cathode catalyst layer 28 includes a catalyst and a proton conductive electrolyte resin. The catalyst is generally a noble metal or an alloy thereof, and is used by means of being supported on a support, such as carbon black, or without being supported. Example catalysts of the anode 22 include a Pt—Ru alloy. Example catalysts of the cathode 23 include Pt.

A cathode flow path plate (not shown) is disposed on the cell 21 on the surface of the cathode 23. Meanwhile, an anode flow path plate (not shown) is disposed on the cell 21 on the surface of the anode 22. Furthermore, the electromotive section 1 is provided with a heater (not shown) for heating the cell 21. A gas (oxidant) containing oxygen—e.g., air—is supplied to the cathode flow path plate; and the fuel 2—e.g., a methanol aqueous solution—is supplied to the anode flow path plate, whereby the cell 21 generates electric power.

A mixing tank 3 is disposed in the fuel cell system. The fuel 2 to be supplied to the electromotive section 1 is stored in the mixing tank 3. The mixing tank 3 and the electromotive section 1 are connected by way of a circulation flow path 4. The circulation flow path 4 is provided for supplying the fuel 2 to the electromotive section 1, and returning to the mixing tank the fuel 2 having been subjected to power generation in the electromotive section 1. The fuel 2 is supplied to the electromotive section 1 and returned to the mixing tank 3 by means of a fuel circulation pump 5 (fuel supply means).

The mixing tank 3 includes fuel concentration detection means 6 and gas-liquid separation means 7. As the fuel concentration detection means 6, there can be employed, e.g., a concentration sensor which measures a methanol concentration by means of measuring the dielectric constant or the refractive index of the fuel 2.

As the gas-liquid separation means 7, there can be employed, e.g., a gas-liquid separation membrane through which a methanol aqueous solution is unable to permeate but through which gas constituents of materials exhausted from the anode 22 as a result of power generation in the electromotive section 1 can permeate. As the gas-liquid separation membrane, a membrane which is water repellent, such as a polytetrafluoroethylene membrane, can be employed. In addition to carbon dioxide produced during the course of power generation, formaldehyde, formic acid, carbon monoxide, and other reaction byproducts contained in the discharged materials can permeate through the water-repellent membrane, such as the polytetrafluoroethylene membrane. Accordingly, the membrane is suitable as the gas-liquid separation means. By virtue of the membrane being capable of separating the reaction byproducts from the fuel 2, measurement accuracy of the refractive index of the fuel 2 is increased.

The mixing tank 3, and a cathode discharge path 9, which is to be described later, are connected by way of a pipe 8. The pipe 8 is provided for exhausting to the cathode discharge path 9 gas constituents of the materials having been discharged from the anode 22 and separated by the gas-liquid separation means 7.

The mixing tank 3 is connected to a concentrated fuel tank 10. The concentrated fuel tank 10 stores a high-concentration fuel. The fuel 2 in the mixing tank 3 declines in concentration as the electromotive section 1 generates power. In a case where a methanol aqueous solution is used as the fuel 2, power generation by the electromotive section 1 consumes water and methanol. The concentrated fuel tank 10 stores methanol whose concentration is higher than that of the fuel 2 for use in power generation so as to replenish the thus-consumed methanol.

A concentrated fuel pump 11 is disposed between the mixing tank 3 and the concentrated fuel tank 10. The concentrated fuel pump 11 is provided so as to supply the high-concentration fuel to the mixing tank 3. The concentrated fuel pump 11 is controlled by control means 19, which will be described later, so that the concentration of the fuel 2 falls within a predetermined concentration range in accordance with the concentration of the fuel 2 measured by the fuel concentration detection means 6.

Oxidant supply means 12 is disposed in the fuel cell system. The oxidant supply means 12 is provided for supplying an oxidant to the electromotive section 1. As the oxidant supply means 12, e.g., an air pump for supplying air outside the fuel cell system to the electromotive section 1 can be employed. More specifically, there can be employed a member for controlling an amount of the oxidant to be supplied to the electromotive section 1, such as a pump of a vane type, a blower type, or a compressor type; an electric fan; a slit for controlling the flow rate of natural convention; or the like.

The oxidant supplied to the electromotive section 1 is used in power generation, and thereafter discharged to a condenser 13, which will be described later, from the electromotive section 1 through the cathode discharge path 9. As described above, the cathode discharge path 9 is connected to the pipe 8. Therefore, in addition to the materials discharged from the cathode 23, the gas constituents of the materials discharged from the anode 22 are discharged toward the condenser 13, which will be described later.

The condenser 13 is provided in the fuel cell system. As the condenser 13, e.g., a heat exchanger can be employed. A portion of the materials discharged to the condenser 13 is condensed by the condenser 13. The “discharged materials to be condensed” referred to here are water vapor produced during the course of power generation by the electromotive section 1, and methanol vapors having permeated through (crossed over) the proton conductive electrolyte membrane 24 or evaporated from the mixing tank 3. A portion of the thus-condensed discharged materials is supplied to the mixing tank 3 by a recovery pump 14 through a pipe 15 so as to be re-used in power generation. The condenser 13 separates liquid constituents of the materials discharged to the condenser 13. The liquid constituents referred to here include discharged materials which are condensed and liquefied.

The fuel cell system has a catalyst section 16. Of the materials having been discharged to the condenser 13, gas constituents which remain after the liquid constituents have been separated from the discharged materials by the condenser 13 are exhausted to the outside the fuel cell system through the catalyst section 16. A catalyst for accelerating a chemical reaction of a portion of the materials discharged from the cathode 23 and materials discharged from the anode 22 is provided inside the catalyst section 16. For instance, a catalyst is provided for accelerating oxidation of a portion of the remaining gas constituents of the materials discharged to the condenser 13. Examples of the gas constituents referred to here whose oxidation is to be accelerated include carbon monoxide, formaldehyde, formic acid, and methanol.

Temperature sensors 17 and 18 can be disposed on the catalyst section 16 respectively on the side of the condenser 13 and the side close to the outside of the fuel cell system. The degree of the chemical reaction accelerated by the catalyst section 16 can be measured by utilizing a difference between temperatures measured by the temperature sensors 17 and 18. For instance, there can be employed such a configuration in which, when the temperature difference measured by the temperature sensors 17 and 18 exceeds a predetermined value, there is made a determination that an allowable limit of chemical reaction by the catalyst section 16 may be violated, and an alarm for urging emergency stop of the fuel cell system is issued. In addition, the amount of the gas constituents whose chemical reactions are to be accelerated by the catalyst section 16 can be estimated on the basis of the thus-measured degree of chemical reaction.

Details of the catalyst section 16 will be described by reference to FIG. 3. The catalyst section 16 has a tubular housing 32 disposed inside an exhaust pipe 31, and a catalyst 34 filled inside the housing 32. A heat insulating member 33 for suppressing heat generated by the accelerated chemical reaction to be transferred to the exhaust pipe 31 can be disposed between the housing 32 and the catalyst 34. By virtue of provision of the heat insulating member 33, the influence on the temperature difference measured by the temperature sensors 17 and 18 exerted by heat transferred to the exhaust pipe 31 is lessened, thereby enabling more accurate measurement of the degree of the chemical reactions to be accelerated.

As the catalyst 34, there maybe employed, e.g., a catalyst formed by means of supporting a noble metal, such as Pt or a Pt—Rt alloy, on a support made of activated carbon, activated alumina, or the like. The catalyst 34 is provided so as to accelerate oxidation of a portion of discharged materials passing through the exhaust pipe 31. The volumetric capacity for storing the catalyst 34 is, for instance, approximately 10 cc in a case of the fuel cell system whose maximum rated power generation is 20 W. The term “rated” referred to here means a state at which the fuel cell system is generating power of an amount at which electric power can be stably supplied to the outside; and the term “maximum rated power generation” means a maximum value of power generation in a range within which the fuel cell system can stably supply electric power to the outside.

Detachment prevention members 35 and 36 prevent detachment of the catalyst 34 to the outside of the housing 32. As the detachment prevention members 35 and 36, e.g., metal nets can be employed.

Details of the control section 19 (control means) will be described. The control section 19 is provided for controlling operations of the fuel cell system. The control section 19 acquires data pertaining to electric power generated by the electromotive section 1; e.g., voltage values and current values. The control section 19 performs its control so that the electromotive section 1 can generate electric power demanded of the fuel cell system on the basis of the data about electric power generated by the electromotive section 1.

The control section 19 controls the flow rate of the fuel 2 to be supplied to the anode 22, and that of the oxidant to be supplied to the cathode 23, and controls the temperature of the electromotive section 1, and the like, as required, thereby enabling the electromotive section 1 to generate electric power demanded of the fuel cell system. The control section 19 controls the flow rate of the fuel 2 by means of controlling the fuel circulation pump 5. The control section 19 controls the flow rate of oxidant by means of controlling the oxidant supply means 12. The flow rate of the fuel 2 is controlled so as to be, e.g., 1.2 mL/min; the flow rate of the oxidant is controlled so as to be, e.g., 100 mL/min; and the temperature of the electromotive section 1 is controlled so as to fall within the range of, e.g., 40 to 60° C.

The control section 19 acquires data pertaining to the fuel concentration measured by the fuel concentration detection means 6. When a methanol aqueous solution is used as the fuel 2, the control section 19 acquires output of the fuel concentration detection means 6; e.g., an output value which changes in accordance with the dielectric constant or the refractive index of the fuel 2, and calculates the data pertaining to the methanol concentration on the basis of the relation between the output values of the fuel concentration detection means 6 and the methanol concentrations having been stored in the control section 19 in advance.

On the basis of the thus-acquired data pertaining to the fuel concentration, the control section 19 controls the concentrated fuel pump 11 and the recovery pump 14 so that the concentration of the fuel 2 stored inside the mixing tank 3 falls within a predetermined concentration range. In addition, the control section 19 can control the fuel circulation pump 5 and the oxidant supply means 12 as required so that the concentration of the fuel 2 stored inside the mixing tank 3 is falls within the predetermined concentration range.

When a methanol aqueous solution is employed as the fuel 2, the control section 19 controls the concentrated fuel pump 11 so as to increase the amount of high-concentration methanol to be supplied to the mixing tank 3, thereby increasing the methanol concentration of the fuel 2. Furthermore, the control section 19 controls the recovery pump 14 so as to increase the amount of the portion of the discharged materials which are condensed and which are to be supplied to the mixing tank 3, thereby lowering the methanol concentration of the fuel 2. In addition, the recovery amount of the discharged materials which are condensed by the condenser 13 and which are mainly constituted of water can be increased by means of, e.g., increasing the cooling capacity of cooling means (not shown) for cooling the condenser 13.

Details of control to be performed by the control section 19 upon start-up of the oxidant supply means 12 will be described. “Start-up of the oxidant supply means 12” referred to here means that the status of the oxidant supply means 12 is changed from a status in which supply of the oxidant to the cathode 23 by the oxidant supply means 12 is stopped to a status in which the same is effected. Meanwhile, the status in which supply of the oxidant is stopped means a status in which the flow rate of the oxidant supplied to the cathode 23 is zero, or significantly small as compared with that during power generation. For instance, in a case where the oxidant supply means 12 is an electric pump or an electric fan, start-up of the oxidant supply means 12 is start of power supply for activation; and, in a case where the oxidant supply means 12 is the slit for controlling the flow rate of natural convection, start-up of the oxidant supply means 12 is a change in slit opening from a substantially-closed state to an open state. The “substantially-closed state” referred to here means a state in which the slit opening is the smallest, or a state in which the slit is opened from the smallest-opening state by a repeatibility error obtained in opening adjustment of the slit.

The control section 19 controls the oxidant supply means 12 as follows upon start-up of the oxidant supply means 12. The control section 19 controls the oxidant supply means 12 so that the amount of the oxidant to be supplied to the cathode 23 gradually increases. “Gradually” referred to here means that the amount of the oxidant to be supplied immediately after start-up of the oxidant supply means 12 is increased with lapse of time. Example cases where the amount is gradually increased include a case where the supply amount is increased in two or more stages as in the case of increasing the same after lapse of a predetermined time from start-up of the oxidant supply means 12, and a case where the supply amount is continuously increased with lapse of time.

Example cases where the oxidant supply means 12 is to be started up include a case where the fuel cell system supplies electric power to a load, such as an object of power supply—which is connected outside the fuel cell system—or a secondary battery disposed inside the fuel cell system. In addition, the example cases also include a case where the fuel cell system is stopped by emergency stop by a certain cause, and thereafter the emergency stop is cancelled.

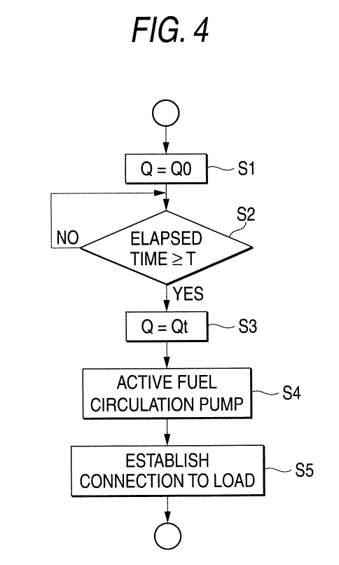

FIG. 4 illustrates an example control performed by the control section 19 for starting up the oxidant supply means 12.

First, the control section 19 controls the oxidant supply means 12 in the stop status so that the oxidant supply means 12 satisfies a condition under which a supply amount Q of the oxidant to be supplied to the cathode 23 becomes Q0 (S1). In the case where the oxidant supply means 12 is an electric pump or an electric fan, the control section 19 performs control so that the oxidant supply means 12 is supplied with electric power which satisfies an activation condition under which the oxidant supply amount to the cathode 23 becomes Q0. In the case where the oxidant supply means 12 is the slit for controlling the flow rate of natural convection, the control section 19 performs control so as to attain the slit opening with which the oxidant supply amount to the cathode 23 is Q0.

Next, the control section 19 controls the oxidant supply means 12 so that the condition under which the oxidant supply amount Q to the cathode 23 is Q0 is maintained for a predetermined period of time T (S2). In the case where the oxidant supply means 12 is an electric pump or an electric fan, the control section 19 performs control so that the electric power supplied to the oxidant supply means 12 in S1 is continuously supplied for the period of time T. In the case where the oxidant supply means 12 is the slit for controlling the flow rate of natural convection, the control section 19 performs control so as to maintain the opening of the slit having been controlled in Si for the period of time T.

After lapse of the period of time T, the control section 19 controls the oxidant supply means 12 so as to satisfy a condition under which the oxidant supply amount Q to the cathode 23 becomes Qt (S3). In the case where the oxidant supply means 12 is an electric pump or an electric fan, the control section 19 performs control so that the oxidant supply means 12 is supplied with electric power which satisfies the activation condition under which the oxidant supply amount to the cathode 23 is Qt. In the case where the oxidant supply means 12 is the slit for controlling the flow rate of natural convection, the control section 19 performs control so as to attain the slit opening with which the oxidant supply amount to the cathode 23 is Qt.

Qt is an amount larger than Q0, and is an oxidant supply amount with which the electromotive section 1 can generate power at a rated output of the fuel cell system. For instance, a relation between Qt and Q0 can be set as follows: Q0<Qt/10.

Next, the control section 19 causes the fuel circulation pump 5 to start operation (S4). “Starting operation of the fuel circulation pump 5” referred to here means that an amount of the fuel 2 to be supplied to the anode 22 by the fuel circulation pump 5 is increased to the oxidant supply amount with which the electromotive section 1 can generate power at the rated output of the fuel cell system.

Finally, the control section 19 connects the electromotive section 1 and the load so as to enable supply of the electric power generated by the electromotive section 1 to the load (S5).

Next will be described phenomena which occur in the electromotive section 1 and the catalyst section 16 in the case where the fuel cell system is controlled by the control section 19 as described above.

When the oxidant supply amount to be supplied to the cathode 23 by the oxidant supply means 12 is Qt (hereinafter called “status A”), the amount of oxygen to be supplied to the cathode 23 is large. Hence, the amount of reaction byproducts and methanol due to crossover, each of whose oxidation is accelerated in the cathode catalyst layer, is large. As a result, the amount of gas constituents which arrive at the catalyst section 16 and whose oxidation is accelerated is to be suppressed.

Meanwhile, in the status where the oxidant supply means 12 stops supply of the oxidant to the cathode 23 (hereinafter called “status B”), the amount of oxygen to be supplied to the cathode 23 is remarkably small as compared with that of status A. Therefore, oxidation of reaction byproducts and methanol due to crossover in the cathode catalyst layer 28 is hardly accelerated.

In addition, since the amount of oxidant in the catalyst section 16 is also small in status B, oxidation of the reaction byproducts and methanol, which remain due to crossover, in the vicinity of the cathode 23 is not accelerated by the catalyst section 16. Hence, the concentration of the reaction by products and that of the methanol due to crossover in the vicinity of the cathode 23 become significantly high.

When the control section 19 performs control so as to bring about a shift from status B to status A, the high-concentration reaction byproducts and methanol due to crossover are supplied to the catalyst section 16 unintentionally rapidly. In addition, thereafter, methanol in a liquid state which remains in the vicinity of the cathode 23 evaporates. Consequently, supply of the large amount of methanol to the catalyst section 16 is continued until the amount of the remaining liquid methanol reaches an allowable limit.

To this end, when a shift from status B directly to status A is not made as in the case of the present embodiment, but the control section 19 performs control so that a shift from status B is made to a status where the oxidant supply amount to be supplied by the oxidant supply means 12 to the cathode 23 is Q0 (hereinafter called “status C”), the high-concentration byproducts and methanol due to crossover are supplied to the catalyst section 16 at a small flow rate. In addition, thereafter, methanol in the liquid state which remains in the vicinity of the cathode 23 evaporates, and methanol is supplied to the catalyst section 16 at a small flow rate until the amount of the staying liquid methanol reaches the allowable limit. Consequently, the capacity per unit time required of the catalyst section 16 to accelerate the chemical reactions of the reaction byproducts and methanol is reduced. This reduction leads to reduction of a required amount of the catalyst 34, thereby eventually contributing to miniaturization of the fuel cell system.

### EXAMPLE

Results of experiments with the embodiment of the present invention will now be described.

First, power generation by a fuel cell system according to the embodiment of the invention was performed for one hour, and thereafter operation of the fuel cell system was stopped.

Next, the fuel cell system was left until a thermometer connected to the surface of the electromotive section 1 indicated room temperature. Thereafter, a vane pump corresponding to the oxidant supply means 12 of the embodiment of the invention was controlled by the control section 19 so that the amount of the oxidant to be supplied to the cathode 23 became 10% of the oxidant supply amount with which the electromotive section 1 could generate power at the rated output of the fuel cell system.

Subsequently, after lapse of 150 seconds from start-up of the vane-type pump, the vane-type pump was controlled by the control section 19 so that the amount of the oxidant to be supplied to the cathode 23 became the oxidant supply amount with which the electromotive section 1 could generate power at the rated output of the fuel cell system.

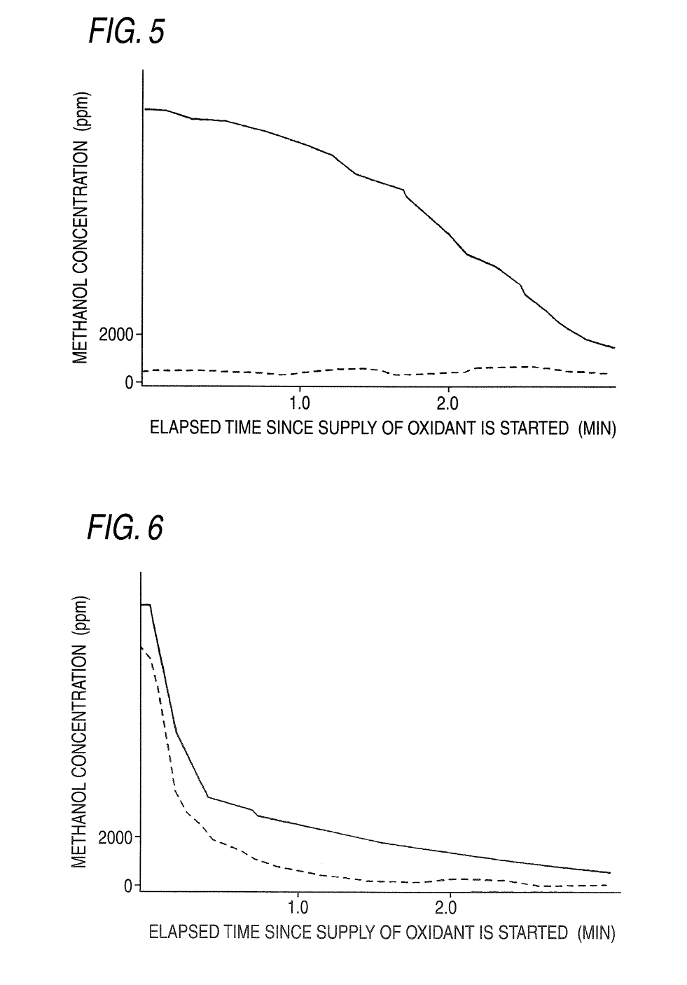

FIG. 5 illustrates concentrations of methanol before and after being supplied to the catalyst section 16. The solid line in FIG. 5 indicates the methanol concentration of gas constituents before being subjected to the catalyst section 16. The dashed line in FIG. 5 indicates the methanol concentration of gas constituents supplied to the catalyst section 16 and thereafter exhausted. The methanol concentrations were measured with use of an infrared absorption spectrometer.

As the catalyst section 16, there was employed such a member which can accelerate oxidation to approximately 200 ppm when the maximum methanol concentration of the remaining gas constituents of materials having been discharged to the condenser 13 was 2,000 ppm under a condition where the oxidant was supplied to the cathode 23 in an amount with which the electromotive section 1 could generate power at the rated output of the fuel cell system.

As shown in FIG. 5, oxidation was confirmed to be accelerated until the methanol concentration of the gas constituents exhausted from the catalyst section 16 became substantially constant (approximately 200 ppm on average).

### Comparative Example

First, as in the case of Example, power generation by the fuel cell system according to the embodiment of the invention was performed for one hour, and thereafter operation of the fuel cell system was stopped.

Next, the fuel cell system was left until a thermometer connected to the surface of the electromotive section 1 indicated room temperature. Thereafter, a vane-type pump corresponding to the oxidant supply means 12 of the embodiment of the invention was controlled by the control section 19 so that the amount of the oxidant to be supplied to the cathode 23 became the oxidant supply amount with which the electromotive section 1 could generate power at the rated output of the fuel cell system.

FIG. 6 illustrates concentrations of methanol before and after being supplied to the catalyst section 16. The solid line in FIG. 6 indicates the methanol concentration of gas constituents before being subjected to the catalyst section 16. The dashed line in FIG. 6 indicates the methanol concentration of gas constituents supplied to the catalyst section 16 and thereafter exhausted. The methanol concentrations were measured with use of an infrared absorption spectrometer.

As shown in FIG. 6, the methanol concentrations of the gas constituents exhausted from the catalyst section 16 were measured high until one minute elapsed since the oxidant supply means 12 had started supply of the oxidant to the cathode 23. This appears to be attributable to supply of methanol to the catalyst section 16 in an amount exceeding the limit within which the catalyst section 16 can accelerate oxidation.

As having been demonstrated in Example, the fuel cell system configured as above can reduce the capacity per unit time required of the catalyst section 16 to accelerate the chemical reaction of the reaction byproducts and methanol. This reduction leads to reduction of a required amount of the catalyst 34, thereby eventually contributing to miniaturization of the fuel cell system.

Meanwhile, the fuel cell system configured as above can also reduce thermal stresses exerted on the catalyst section 16 upon start-up of the oxidant supply means 12.

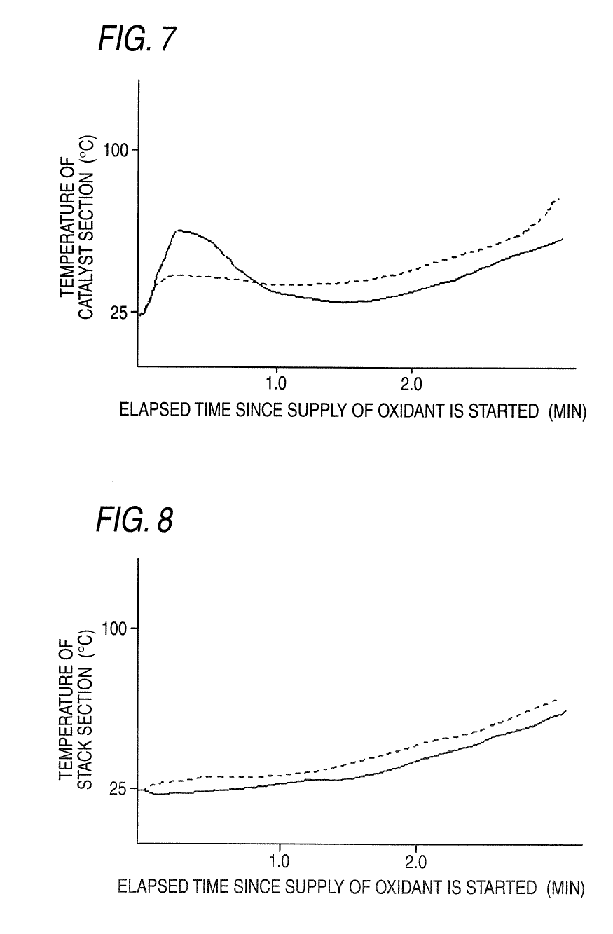

FIG. 7 is a diagram in which transition of the temperature measured by the temperature sensor 18 in Example and that in Comparative Example are plotted. The dashed line indicates the temperature measured by the temperature sensor 18 in Example, and the solid line indicates that in Comparative Example.

As shown in FIG. 7, the temperature measured by the temperature sensor 18 in Example increases more sharply after start-up of the oxidant supply means 12 than that in Comparative Example. This phenomenon appears to be attributable to heat which was generated in oxidation accelerated by the catalyst section 16 and which was excessive in amount as compared with that released from the catalyst section 16.

Mixture of metal ions into the electromotive section 1 in a fuel cell system is known to cause critical damage to the electromotive section 1. Therefore, each of the supply and discharge paths of the fuel and the oxidant is made of a non-metal material to the greatest possible extent. Being inexpensive and excellent in formability, a resin material is particularly appropriate for the housing 32 and the exhaust pipe 31.

However, when heat generated in oxidation accelerated by the catalyst section 16 is excessive, the housing 32 and the exhaust pipe 31 are distorted, thereby increasing a possibility of causing irreversible damage. This tendency becomes more pronounced as the temperature of the catalyst section 16 upon start-up of the oxidant supply means 12 increases. In the fuel cell system according to Example, a rise in temperature of the catalyst section 16 is moderated. Therefore, such a possibility of causing irreversible damage to the catalyst 34 can be reduced.

In addition, the fuel cell system configured as above can shorten a restart time which elapses from restart of the system after a long shut-down time to a time when the system enters a status in which the system can again supply electric power to a load.

FIG. 8 is a diagram in which transition of the temperature measured by a thermometer connected to the electromotive section 1 in Example and that in Comparative Example are plotted. The dashed line indicates the temperature of the electromotive section 1 in Example, and the solid line indicates the temperature of the electromotive section 1 in Comparative Example.

As shown in FIG. 8, the temperature of the electromotive section 1 in Example rises in a shorter time as compared with that of Comparative Example. This appears to be attributable to: since the flow rate of the oxidant flowing to the cathode 23 was small in Example, the amount of heat derived from the electromotive section 1 by the oxidant was small. In addition, this also appears to be attributable to: since the flow rate of the oxidant flowing to the cathode 23 was small in Example, the amount of methanol which was directly discharged—with its oxidation not being accelerated by the cathode catalyst layer 28—became small; as a result, the ratio of methanol whose oxidation was accelerated by the cathode catalyst layer 28 became high.

More specifically, the temperature of the electromotive section 1 can be increased to a temperature at which generation efficiency of the electromotive section 1 is high in a shorter period of time. Put another way, the restart time which elapses until the fuel cell system enters the status at which the system can again supply electric power to the load.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fuel cell system comprising:
an anode electrode to which fuel is to be supplied;
a cathode electrode to which an oxidant containing air or oxygen is to be supplied;
an electrolyte membrane disposed between the anode electrode and the cathode electrode;
a catalyst section configured to accelerate a chemical reaction of at least a portion of a material discharged from the cathode electrode and a material discharged from the anode electrode;
an oxidant supply unit configured to supply the oxidant to the cathode electrode; and
a control unit configured to control an amount of the oxidant to be supplied to the cathode electrode, wherein
the control unit controls the oxidant supply unit to increase the amount of the oxidant when the oxidant supply unit starts to operate.

2. The fuel cell system according to claim 1, wherein
the catalyst section includes a catalyst configured to accelerate oxidation.

3. The fuel cell system according to claim 1, wherein
the control unit controls the oxidant supply unit to increase gradually.

4. The fuel cell system according to claim 1, wherein
the catalyst section includes a first temperature sensor on one side close to the outside of the fuel cell system.

5. The fuel cell system according to claim 1, wherein
the catalyst section includes a second temperature sensor on the other side of the catalyst section.

6. The fuel cell system according to claim 1, wherein
the catalyst section includes a first temperature sensor on one side close to the outside of the fuel cell system and a second temperature sensor on the other side of the catalyst section.

7. The fuel cell system according to claim 6, wherein
the control unit measure a degree of the chemical reaction from difference between temperatures measured by the first temperature sensor and the second temperature sensor.

8. A control method for a fuel cell system which includes:
an anode electrode to which fuel is to be supplied;
a cathode electrode to which an oxidant containing air or oxygen is to be supplied;
an electrolyte membrane disposed between the anode electrode and the cathode electrode;
a catalyst section configured to accelerate a chemical reaction of at least a portion of a material discharged from the cathode electrode and a material discharged from the anode electrode; and
an oxidant supply unit configured to supply the oxidant to the cathode electrode, the method comprising:
starting an operation of the oxidant supply unit; and
controlling the oxidant supply unit to make Q0 smaller than Qt, wherein
Q0 is an amount of the oxidant at a start-up of the oxidant supply unit, and
Qt is an amount of the oxidant after lapse of a predetermined time from the start-up of the oxidant supply unit.

9. A control method for a fuel cell system according to claim 8, further comprising:
increasing the amount of the oxidant gradually.

10. A control method for a fuel cell system which includes:
an anode electrode to which fuel is to be supplied;
a cathode electrode to which an oxidant containing air or oxygen is to be supplied;
an electrolyte membrane disposed between the anode electrode and the cathode electrode;
a catalyst section configured to accelerate a chemical reaction of at least a portion of a material discharged from the cathode electrode and a material discharged from the anode electrode;
a fuel supply unit configured to supply the fuel to the anode electrode; and
an oxidant supply unit configured to supply the oxidant to the cathode electrode, the method comprising:
starting up an operation of the oxidant supply unit at a start-up of the fuel cell system;
increasing an amount of the oxidant to be supplied to the cathode electrode by the oxidant supply unit after lapse of a predetermined time from the start-up of the operation of the oxidant supply unit;
starting up an operation of the fuel supply unit after the amount of the oxidant to be supplied is increased; and
supplying a load with electric power generated by the anode electrode, the cathode electrode, and the electrolyte membrane after the start of the operation of the fuel supply unit.
